(19) United States
(12) Patent Application Publication
(10) Pub. No.: US 2004/0260769 A1
(43) Pub. Date: Dec. 23, 2004

(54) Method and apparatus for distributed cache control and network system

(76) Inventor: Junji Yamamoto, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/862,379

(22) Filed: Jun. 8, 2004

(30) Foreign Application Priority Data
Jun. 18, 2003 (JP) 2003-172773

(51) Int. Cl. G06F 15/16; G06F 12/00

(52) U.S. Cl. 709/203; 711/137

(57) ABSTRACT

To suppress the peak traffic on a network, a control server for making a plurality cache servers cooperative is provided on the network and the control server is caused to predict a demand for specified data. In connection with data for which the demand is expected to increase, the data is copied and distributed in advance to a cache server subordinate to the control server.

### INCORPORATION BY REFERENCE

The present application claims priority from Japanese application JP2003-172773 filed on Jun. 18, 2003, the content of which is hereby incorporated by reference into this application.

### BACKGROUND OF THE INVENTION

The present invention relates to method and apparatus for controlling caches distributed in an information network and a network system to which the control method is applied.

When a plurality of clients make reference to or consult the same data, the network traffic caused to occur during access can be closed between a client and a cache server by using a cache technique and consequently the amount of traffic throughout a network can be suppressed. But the traffic generated in a large-scale network cannot be dealt with by means of a single cache server and typically a plurality of cache servers are arranged in a distributed fashion.

JP-A-2002-251313 discloses a technique for making a plurality of cache servers cooperative. In an invention disclosed in this reference, a parent server for controlling plural cache servers is provided and the parent server stores information concerning cache data the individual cache servers hold. Then, the parent server makes collation as to whether any subordinate cache server holds data requested by a client. If a subordinate cache server holding the requested data is present, the parent server acquires the requested data from that cache server. Or, the parent server causes the data to be transferred or copied to a cache server connected to the client making the request. By cooperatively controlling multiple cache servers in this manner, the frequency of access to an external network can be reduced and time of response to the request for data made by the client can be shortened. In addition, the amount of cache data held by each cache server can also be decreased.

JP-A-11-024981 discloses a technique for prefetching cache data. In the technique disclosed in this reference, a cache server comprises an access history database for recording accessed files and a prefetch data selection module, wherein data to be prefetched next is determined on the basis of a file subject to higher access frequency and an update interval of the file and the prefetch data is cached in advance during a time zone in which the traffic amount of the network is uncrowded. According to the technique as above, the cache hit rate can be improved and the speed of file access can be increased.

In RFC (Request For Comment) 2186 and 2187 issued from IETF (Internet Engineering Task Force), ICP (Internet Cache Protocol) is stipulated as a method of making cache servers cooperative. An example of construction of a network 10 using the ICP is illustrated in FIG. 14. Clients 17 and 18 are connected or coupled to a cache server 13 through a router 14 and clients 19 and 20 are connected to a cache server 15 through a router 16. The routers 14 and 16 are connected to a superordinate router 12 through the medium of an internal network. The router 12 is connected to an external network. Each of the routers 14 and 16 is connected with the cache server having a cache memory holding cache data.

In the ICP, when data requested by a client is absent in a cache, another cache is inquired. If the latter cache holds the data in question, the data is obtained from that cache, so that data need not be acquired externally of the network and the response time can be improved or shortened.

### SUMMARY OF THE INVENTION

In the prior art, many packets are issued during inquiry and hence the traffic inside the network tends to increase. Further, in case inquires are made from many clients within a short period of time, many cache servers are activated to start acquisition of data and consequently the traffic is further increased. Accordingly, in the event that a request for access to specified contents is made unexpectedly, such an event cannot be dealt with.

It is an object of the present invention to suppress the peak traffic on a network.

According to the invention, in a network applied with a distributed cache control and connected with a plurality of clients, a plurality of cache servers and a control server for controlling the multiple cache servers are provided. On the basis of a status of data held in a cache server or a change in the status, the control server issues an order to copy data requested to be accessed by a client, from a cache server holding the data in question to a different cache server not holding that data.

According to the invention, the peak traffic of the network can be suppressed.

Other features and advantages of the invention will be detailed in conjunction with the accompanying drawings in which there are illustrated and described embodiments of the invention.

### BRIEF DESCRIPTION OF THE DRAWINGS

FIG. 1 is a diagram showing an example of construction of a network for distributed cache control.

FIG. 2 is a block diagram showing a module construction of a control server.

FIG. 3 is a diagram showing a structure of an access history table based on a method for making a demand prediction by using time stamp.

FIG. 4 is a flowchart of operation when a request from a subordinate server is received.

FIG. 5 is a diagram showing a status of the access history table.

FIG. 6 is a diagram showing another status of the access history table.

FIG. 7 is a diagram showing still another status of the access history table.

FIG. 8 is a diagram showing still another status of the access history table.

FIG. 9 is a diagram showing an example of construction of a network having a hierarchical structure for distributed cache control.

FIG. 10 is a flowchart of operation when a copy order is received from a superordinate server.

FIG. 11 is a flowchart of operation when a data copy order is received from another server.

FIG. 12 is a block diagram showing a module construction of a router with a packet filter.

FIG. 13 is a block diagram showing a router construction having a multi-stage packet filter.

FIG. 14 is a diagram showing a network construction in the prior art.

### DESCRIPTION OF THE EMBODIMENTS

(Embodiment 1)

The invention will now be described by way of example with reference to the accompanying drawings.

(Explanation of Construction)

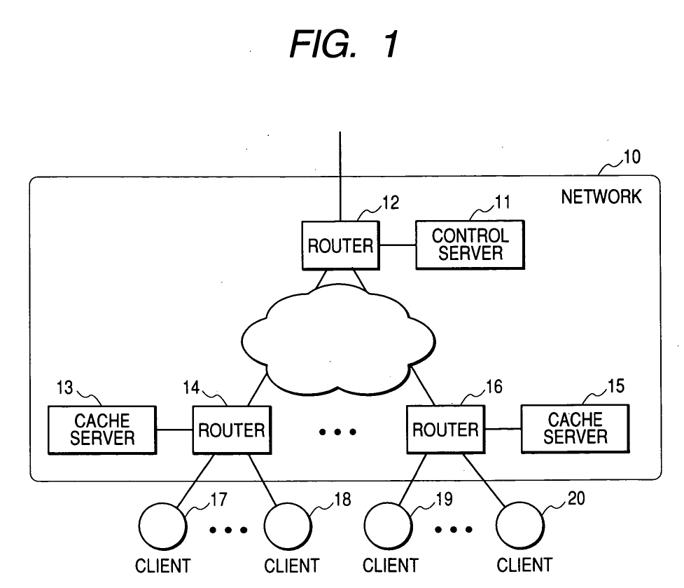

Referring now to FIG. 1, there is illustrated one example of construction of a network to which the invention is applied. Clients 17, 18, 19 and 20 are, for example, end users connected or coupled to the network designated by reference numeral 10. A first router group includes routers 14 and 16 adapted to concentrate access lines extending from a plurality of clients. For example, the first router corresponds to an access router, BAS (Broadband Access Server) or gateway arranged on the network. The number of clients accommodated by the first router needs not always be plural. For convenience of illustration, only the two first routers 14 and 16 are depicted but it will be appreciated that multiple first routers connected to an internal network are arranged between the routers 14 and 16. Hereinafter, the first routers subordinate to a control server 11 are generally termed a “first router group”.

Designated by 13 and 15 are cache servers connected to the first routers 14 and 16, respectively. A second router 12 is adapted to further accommodate the first router group including the routers 14 and 16 and is arranged on the network internally or backwardly of the first router group as viewed from the clients. The first and second routers are connected with each other by the internal network which is, for example, a LAN or another closed network.

Thus, the network 10 comprises the first router group, the cache servers, the second router and the internal network. As an example of this type of network, there is available an access network for enabling an end user to connect to the Internet. Though not shown, a network different from the network 10 exists upwardly (in the drawing) of a line extending from the second router 12 and the second router of the present embodiment is arranged at a connection portion to the different network.

Connected to the second router is the control server 11 adapted to control operation of the plural cache servers 13 and 15. More specifically, the control server 11 supervises requests for cache data sent from the individual cache servers and transmits, to a subordinate cache server, an order to copy data, an increasing request for access to which is predicted on the basis of the result of supervisory.

More detailed operation step of the control server will be described in greater detail in a later chapter “Explanation of Operation”.

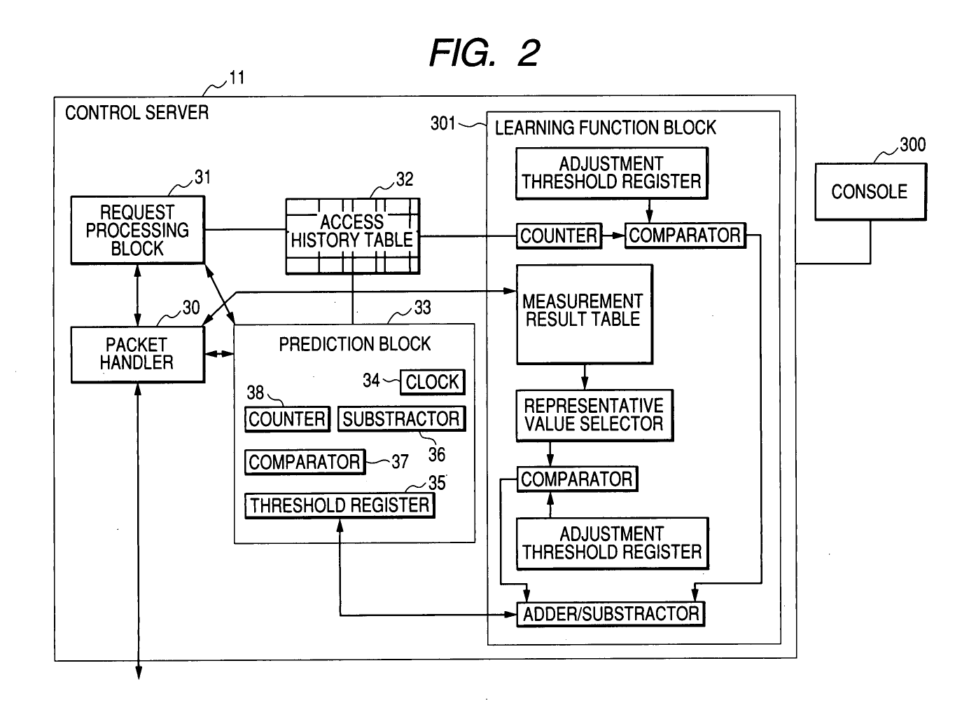

Turning to FIG. 2, an example of construction of the control server 11 is illustrated. A packet handler 30 takes charge of transmission/reception of packets and is constructed of, for example, an interface card for input/output of packets. A request processing block 31 processes requests and responses from subordinate cache servers and it can be implemented with a processor or ASIC, for instance. An access history table 32 is a table for recording a history of requests from subordinate cache servers or subordinate control servers and is constructed of, for example, a storage means such as a memory or hard disk. The request processing block 31 consults the access history table 32 during data processing. A prediction block 33 predicts coming access on the basis of information in the access history table 32. Designated by 301 is a learning function block. As will be described later, the learning function block is not always indispensable. For execution of access prediction, various methods can be employed and the internal construction of the prediction block 33 changes with the prediction method but in the present embodiment, an internal construction of the prediction block employed when an access prediction is made pursuant to time stamp is illustrated.

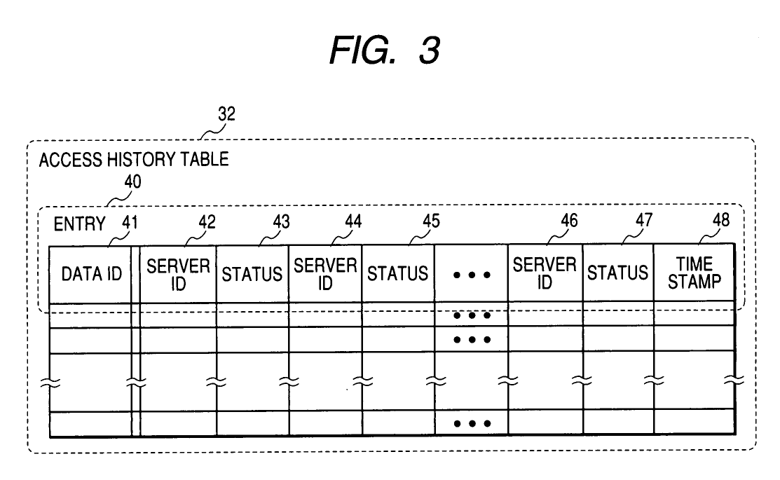

The prediction block 33 in the present embodiment includes a clock 34 for indicating time at present, a counter 38 for counting the number of registered server ID's contained in an entry 40 (see FIG. 3) of the history table, a subtracter 36 for determining the difference between a value at time stamp field 48 (see FIG. 3) and that of the clock 34, a threshold register 35 for holding prediction conditions, and a comparator 37 for comparing an output of counter 38 or subtracter 36 with a value of threshold register 35.

An example of a structure of the access history table when the time stamp is used as prediction method is depicted in FIG. 3. The access history table 32 is comprised of a set of entries 40 and each entry 40 is then comprised of a plurality of fields in which data is stored actually. The respective fields are blanked under the default condition.

An ID of requested data is recorded at data ID field 41. Here, the data ID is a unique identifier allotted to data and contents requested by clients and for example, a URL or IP address of a storage destination of data is recorded. Alternatively, a serial number may be assigned to pieces of requested data. ID's of directly subordinate servers requesting the data recorded at data ID field 41 are recorded at server ID fields 42, 44 and 46.

Here, the “directly subordinate server” means a server managed by the superordinate server per se and in the case of the network system of FIG. 1, servers corresponding to “direct servers” of the second router are the cache servers 13 and 15. In case a relay node unit is further provided in the internal network and a server having the control function is connected to the relay node unit, a server directly managed by the control server 11 is the server connected to the relay node unit and therefore, the “directly subordinate server” is the node unit arranged in the internal network.

Stored at server ID is an unique identifier assigned to a “directly subordinate server”, for example, an IP address of each subordinate server. When a unique number is assigned to a router or node unit accommodated by the second router, this number can be stored at server ID field. In this case, however, a table making the correspondence between server ID and IP address of each server needs to be managed, with the result that management becomes complicated slightly.

Registration status of cache data in each server is paired with each server ID field so as to be recorded at status field 43, 45 or 47. Stored at the status field is an identifier for indicating whether given cache data is placed in commit, that is, real registration status or temporary registration status. Final time that a final server ID is registered in the entry 40 is held at time stamp field 48.

When receiving a data request packet from a subordinate first router or a data copy packet from an original server originally holding data requested by a client, the second router 12 transfers the received packet to the control server. Apart from the transfer of the received packet per se, header information may be cut out of the received packet so as to be transferred. Alternatively, copy data of the received packet may be transferred to the control server.

Receiving the packet from the second router, the packet handler 30 transfers the received packet to the request processing block 31. The request processing block 31 starts the prediction block 33 to cause it to execute a prediction of a demand for the data, access to which is requested, or for the data transferred from the original server (hereinafter simply referred to as “data”).

By consulting the history table 32, the prediction block 33 acquires, from time stamp field in a corresponding entry, the latest registration time of the data in question. The prediction block 33 also acquires, from the clock 34, a time at which it received a start command from the request processing block 31 (present time). The clock 34 can be implemented with, for example, a counter clock attached to the processor. The acquired registration time and present time are inputted to the subtracter 36 and a difference therebetween is calculated. The calculated difference and threshold data stored in the threshold register 35 are inputted to the comparator at a time. When the difference is smaller than a value stored in the threshold register, it is determined that the interval between requests for access to the data exceeds a threshold. In other words, the demand for access to that data is so determined as to increase on and after the present time. If the difference is larger than the stored value, it is determined that the interval between requests for access to the data in question does not exceed the threshold yet and the demand for access to that data is determined not to increase on and even after the present time. The result of decision is sent to the request processing block 31.

The request processing block 31 executes a copy order on the basis of the result sent from the prediction block 33. In case the decision result transmitted from the prediction block 33 indicates an increasing demand, the request processing block 31 transmits, to the cache server holding the data requested to be accessed, an order to cause it to copy that data to not only the cache server representing the access request source but also all subordinate cache servers. In an alternative, the data sent from the original server is transmitted to all subordinate cache servers. If the prediction result from the prediction block 33 does not indicate an increasing demand, the data of interest is copied to only the cache server subject to data access request.

The data copy based on the prediction operation implies that data movement among cache servers due to coming expectant occurrence of requests for the data from clients is executed in advance at the time that the prediction operation is completed. Accordingly, by carrying out the present embodiment, a time at which the traffic peaks can be shifted, that is, the peak traffic can be flattened.

The control server in the present embodiment includes a console 300 having a means for inputting numerical values and an operation screen, so that the value to be held in the threshold register 35 can be changed freely by system users.

In addition, the value to be held in the threshold register 35 may be optimized by providing the control server with the learning function. To this end, the learning function block 301 is provided. In case requests are received from the majority of the cache servers subordinate to the control server before the prediction operation proceeds, the issuance of an order to copy is regarded as being retarded and the value of the threshold register is increased to expedite the timing of issuance of the copy order. On the other hand, if a request from a client reaches later than the timing of a copy order, the value of the threshold register is decreased to retard the issuance of the copy order.

It is necessary for making the value of threshold register 35 smaller to decide that the arrival of a request from a client is later than the timing of the copy order. Accordingly, the cache server measures a time consumed between the arrival of a copy order and the arrival of a request from a client and transmits a result of measurement to the control server 11. Therefore, each cache server has a clock means for measuring time and a recording means for storing a data ID of data for which time is measured and a measured time by making the correspondence therebetween. As the recording means, a management table formed in a memory or disk device, for example, may be used or alternatively, the data ID and time data may be stored directly in the register.

When a learning operation is to proceed, the request processing block 31 first starts the learning function block 301. When started, the learning function block 301 requests the packet handler 30 to receive a data ID forwarded from a client and transmitted from a cache server and time data and stores the data the packet handler transmits in a measurement result table. A representative value selector calculates or selects a representative value from the data stored in the measurement result table and delivers it to a comparator. On the other hand, an adjustment threshold register is stored with a predetermined threshold value (called an adjustment threshold) and when the representative value is inputted, the comparator fetches the threshold from the adjustment threshold register to compare the representative value with the threshold.

If the representative value is larger than the threshold, it is determined that the arrival of the request from the client is later than the timing of copy order and the threshold stored in the threshold register is incremented by a predetermined negative value by means of an adder/subtracter. As the representative value, cumulated data of times measured by each cache server or an average value of measured times can be used. The value to be incremented may be stored in the threshold register, adjustment threshold register or a register inside the adder/subtracter. The increment value may also be set freely by the user through the use of the console.

When the entry is updated by a command from the request processing block 31, an updated entry in the access history table 32 is transmitted to the learning function block 301. The learning function block 301 inputs the received entry to a counter. The counter counts server ID's registered in the entry and inputs a count to a comparator. On the other hand, an adjustment threshold register is stored with a predetermined threshold value (called an adjustment threshold) and when the number of registered server ID's (registration number) is inputted, the comparator compares the registration number with the adjustment threshold.

If the registration number is larger than the adjustment threshold, start of a prediction operation is determined and a command is sent to the adder/subtracter to cause it to increment the threshold stored in the threshold register. When receiving the increment command at the time that the prediction block does not start the prediction operation, the adder/subtracter increments the threshold value stored in the threshold register by a predetermined positive value. The incrementing value may be stored in the threshold register or adjustment threshold register or alternatively in a register inside the adder/subtracter. The incrementing value can also be set by the user through the console.

For example, the learning operation can be executed at the timing that copy data is transmitted to a subordinate server. In case data of a data ID, access to which is not requested by each of the cache servers, is sent to each cache server from the control server 11, each cache server determines that copy data is transmitted and starts time measurement. If a packet for requesting access to the data of the data ID is received from a client, the cache server stops measuring and transmits measured time data and the data ID to the control server 11.

For transmission of the measured time data to the control server, two methods are available, of which one is to transmit all of the measured time data to the control server irrespective of which server ID is involved and the other is to transmit the measured data to the control server only when the measured time is larger than the threshold for decision but is not to transmit when smaller. In the latter case, the amount of traffic between the control server and the cache server can be reduced to advantage.

(Explanation of Operation)

As operational modes of the network system having the topology of FIG. 1, the following three modes are conceivable.

1) Data is not cached in any cache servers arranged in the network system.

2) Data has already been cached in any of the cache servers arranged in the network system and an access request is issued from a cache server not caching the data.

3) Requests for accessing the same data are issued from a plurality of cache servers.

Firstly, a first operational example will be described in which data is not cached in any cache servers in the network system.

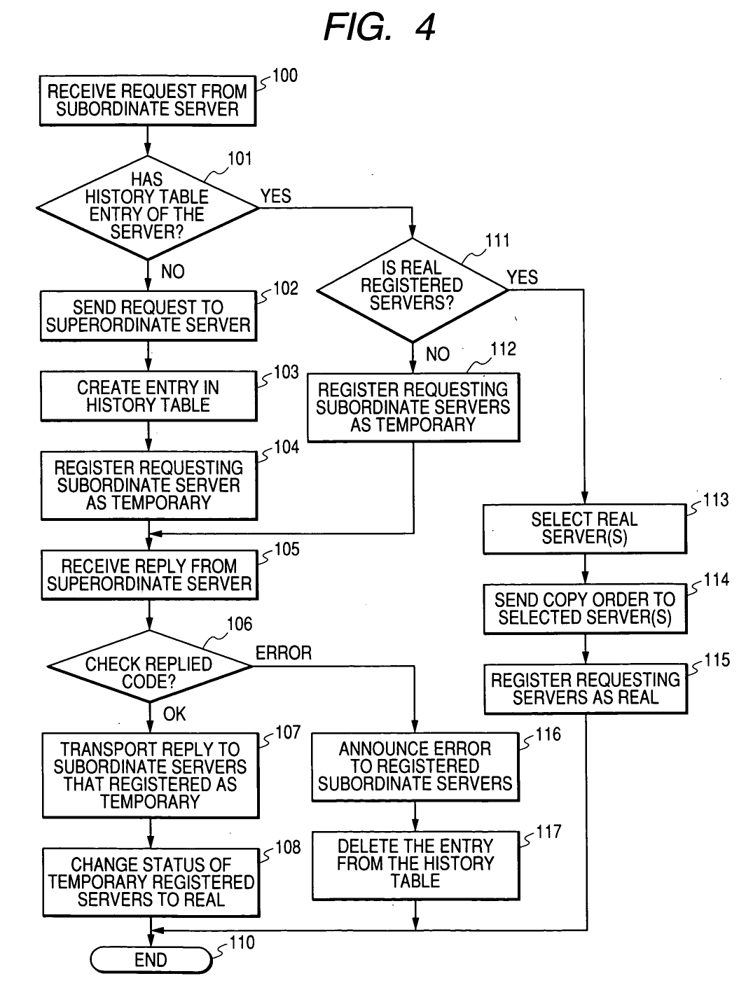

The first operational example will be described by making reference to Steps 100 to 117 in a flowchart shown in FIG. 4.

For example, when the client 17 desires to obtain data of a given data ID in the network having the topology of FIG. 1, the client 17 requests the data by transmitting a data request packet to the cache server 13. Assumptively, in the present embodiment, the data request packet is transmitted to acquire data of a number having a data ID of “700”. In addition to numerals, any type of identifiers may be used as the data ID provided that the uniform or definite relation can be determined between data and data ID. A URL (Unified Resource Locator) of a data original server of the requested data may be used. For example, when the URL is assumed to be http://www.xxx.com/id#700, the http://www.xxx.com/id#700 as it is can be used as the data ID. Without the knowledge of an IP address of the cache server 13, the client 17 transmits the data request packet to the original server. In any case, the data request packet forwarded from the client is passed through the first router without fail. When receiving the data request packet from the client, the first router 14 transfers the received packet to the cache server 13. If the cache server 13 does not hold the requested data, the cache server 13 then transmits a new data request packet to the control server 11.

Next, an operation flow of the control server will be described by making reference also to the flowchart of FIG. 4.

When receiving a request for data acquisition in Step 100, the control server 11 consults the access history table 32 to confirm, in Step 101, the presence/absence of an entry in which an ID of data, access to which is requested, is stored at data ID field. If the entry is absent, implying that the data of that ID is data any access to which was not requested in the past, the program proceeds to Step 102 and the control server 11 transmits a packet requesting data acquisition to a server superordinate to the control server 11. In the case of the FIG. 1's network system, the data request packet is transmitted to an original server holding the data requested to be accessed.

After transmission of the data request packet, the control server 11 newly prepares an entry 40 in the access history table 32 in Step 103 and registers data ID 700 at data ID field 41. Thereafter, in Step 104, an ID of a subordinate server having transmitted a request directly to the control server is written at server ID field 42. In the case of the network of the topology shown in FIG. 1, the server subordinate server to the control server 11 corresponds to either the cache server 13 or 15 and in this instance, the cache server 13 has transmitted the data request packet and a server ID of “13” is recorded at server ID field. In addition to numerals such as “13”, any type of identifier assigned to each cache server such as an IP address can be used. Written at status field 43 is a value indicative of temporary registration.

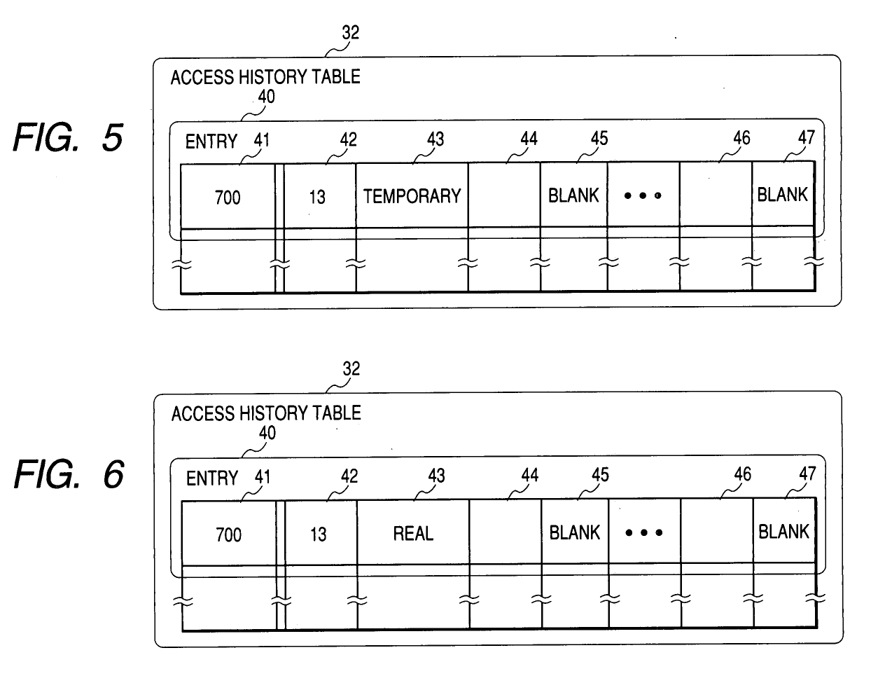

A status of access history table 32 at the termination of the Step 104 is shown in FIG. 5. The entry 40 is prepared in which the data ID, “700”, is stored at data ID field and the server ID, “13”, is stored at the first server ID field. A status value “temporary” indicative of temporary registration is stored at the first status field 43 paired with the first server ID field. In the case of the network having the topology of FIG. 1, the server ID fields prepared in the entry 40 are identical in number to the cache servers subordinate to the control server 11. In the phase of completion of the step 104, other server ID fields and status fields 44 to 47 and time stamp field 48 are blanked.

When receiving a response packet 603 from the superordinate server in Step 105, the control server 11 confirms an acknowledgement code in the response or reply packet in Step 106. The “acknowledgement code” referred to herein is an identifier indicating whether the requested data is present or absent in the original server and is stored in the reply packet. In the absence of the requested data in the original server, an acknowledgement code indicative of a response error is allotted to the packet. If the acknowledgement code is not of error, the program proceeds to Step 107 and the control server 11 sends a response data packet to the subordinate server 13 for which “temporary” is recorded at status field in the entry 40. After transmission of the response data packet, the control server records, in Step 108, a status value “real” indicative of real registration status at status field of server ID 13 in the entry 40. When the cache server 13 receives the response data packet from the control server, it registers the data in the cache and then transmits a response data packet 605 to the client 17 having requested the data.

If the acknowledgement code is determined to be of error in the Step 106, the program proceeds to Step 116 and the control server 11 informs all servers, for which server ID fields in the entry 40 are not blanked, of the response error and deletes the entry of interest in Step 117.

A status of access history table 32 at the termination of Step 108 in FIG. 4 is shown in FIG. 6. It will be seen that as compared to the entry of access history table shown in FIG. 5, the value of status field 43 is changed to “real”.

Next, a second operational example carried out when a cache server having already cached data is present and under this condition, another cache server issues a request will be described.

It is now assumed that in the network having the FIG. 1's topology, the cache server 13 caches data having a data ID of 700. In this case, an entry 40 as shown in FIG. 6 is prepared in the access history table 32 of control server 11. That is, stored at server ID field is the ID of the server having already cached the data and stored at status field corresponding to the server ID field is an identifier “real” indicative of real registration status. When desiring to acquire the data 700, the client 20 transmits a request packet to the cache server 15 or the first router 16. The cache server 15 determines that the data 700 is not held in the cache of its own and transmits the request packet to the control server 11. The control server 11 receives the request from the cache server 15 and this operation corresponds to Step 100 in FIG. 4.

The control server operates as will be described with reference to FIG. 4. When the control server receives a data access request from the cache server 15 representing a subordinate server, the request processing block 31 of control server 11 starts operating in Step 101. In Step 101, because of the presence of the entry 40 having data 700 in the access history table 32, the program proceeds to Step 111. Since real registration is indicated at status field 43 in the entry 40, the program proceeds from the Step 111 to Step 113.

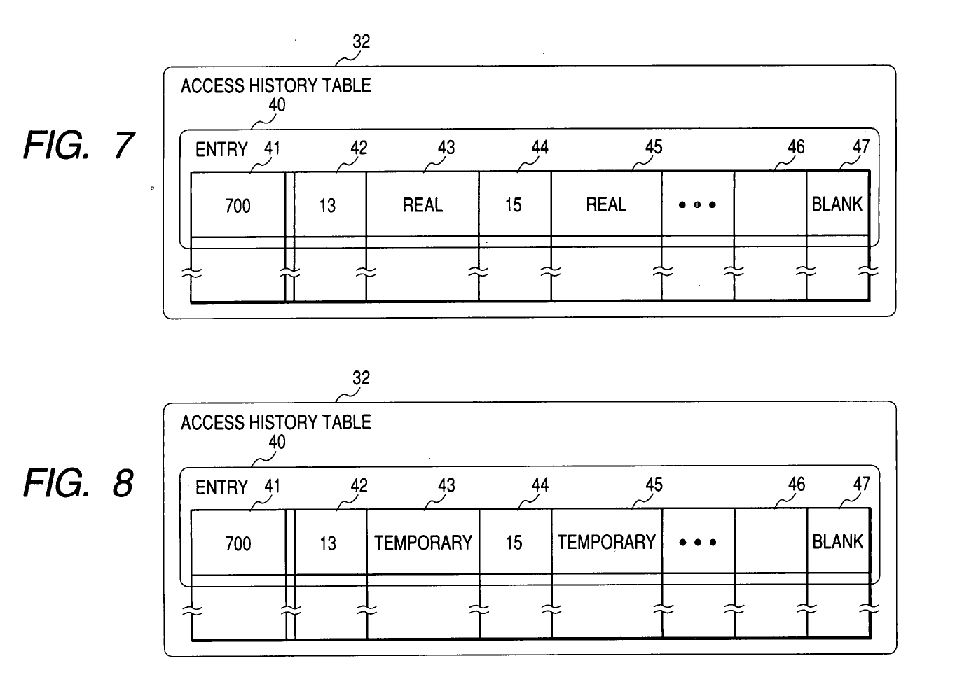

In Step 113, one of server ID's exhibiting real registration status is selected from the entry 40. This operation is executed by the request processing block 31. In this instance, the cache server 13 recorded at server ID field 42 is selected. In the next Step 114, a command packet is transmitted to the selected cache server 13. In Step 115, “15” and “commit” are written at server ID field 44 and status field 45, respectively, in the entry 40, so that the entry 40 takes a status as shown in FIG. 7.

When receiving the command packet, the cache server 13 follows the command to transmit or copy a transfer packet carrying the data of ID 700 to the cache server 15. Upon reception of the transferred packet, the cache server 15 registers the data 700 in the cache and transmits a response packet to the client 20.

Finally, a third operational example carried out when access requests are issued to the same data from a plurality of cache servers will be described.

An instance will be considered in which the clients 17 and 20 try to obtain the same data 700 in the network having the topology shown in FIG. 1. Assumptively, in this case, a data access request from the client 17 first reaches the control server and a data access request issued by the client 20 reaches the control server later. Firstly, the client 17 transmits a data request packet to the cache server 13. If the cache server 13 does not hold the data 700, it transmits the request packet to the control server 11.

Following the control flow of FIG. 4, the control server 11 executes Steps 100 to 104 and then transmits the request packet to a superordinate server. After the execution of Step 104, in an entry 40 of access history table 32, “700” is indicated at data ID field 41, “13” is indicated at server ID field 42 and “temporary” registration is indicated at status field 43 as shown in FIG. 5. The client 20 transmits a request packet to the cache server 15, which in turn transmits the request packet to the control server 11. Following the control flow of FIG. 4, the control server 11 receives the packet in Step 100 and thereafter checks the access history table 32 in Step 101. Since the response to the access request from the client 17 is executed up to Step 104, the entry 40 having 700 representing the value of data ID field is present in the access history table 32. Accordingly, the control server 11 advances the program to Step 111. In Step 111, the entry 40 is checked. A response from the original server has not been returned yet and therefore, the status field 43 corresponding to the server ID field 42 and prepared precedently is not brought into a real registration status. Then, the control server 11 advances the program to Step 112. The request processing block 31 records a server ID of cache server 15 at a blank server ID field in the entry 40. A status of access history table 32 after the execution of Step 112 is shown in FIG. 8.

As a response packet from the superordinate server reaches the control server 11, the control server 11 resumes the program starting from Step 105 and in Step 107, it transmits the response packet to each of the cache servers 13 and 15. Each of the cache servers 13 and 15 caches and registers data in the response packet transmitted from the control server and transmits, as a response packet, the access requested data to each of the clients 17 and 20.

In case a large time lag prevails until the access request by the client 20 reaches the control server 11 following the arrival of the access request by the client 17, so that the access request from the client 20 reaches the control server 11 after the control server 11 receives the response from the superordinate server, the response to the access request from the client 20 is dealt with though the route of Steps 101, 111 and 113 in the flowchart of FIG. 4.

Contrarily, if the data access requests from the clients 17 and 20 are transferred to the control server 11 substantially simultaneously, one of the data access requests having reached even slightly earlier is processed earlier. Therefore, the packet handler 30 of control server 11 includes a buffer memory for queuing the received data request packets.

Operation during prediction will now be described.

Firstly, the timing of occurrence of prediction operation will be described using the flowchart of FIG. 4. As an example, the timing is the time that a request source cache server is committed, that is, really registered in the access history table (Step 110 in FIG. 4). As another example, the timing is the time that a request source cache server is temporarily registered in the access history table 32 (Steps 104 and 112 in FIG. 4). As still another example, the timing is the time that a cache server which has already been committed is selected (timing of Step 113 in FIG. 4).

When a prediction operation occurs in Step 110, 104 or 112 in FIG. 4, data is collectively transmitted, at the time that the data is transferred to the request source cache server (Step 107 in FIG. 4), to not only the request source cache server but also a cache server made to be a destination of the data by the prediction operation.

In addition, when a prediction operation occurs at the time of Step 113 in FIG. 4, a command to send copy data to not only the request source cache server but also a cache server made to be a destination of the data by the prediction operation is issued at the time that a copy order is sent (Step 114 in FIG. 4).

It can be set freely, by storing sequence data in the request processing block 31 of control server 11, which time point the prediction operation is caused to occur at. The setting is carried out through the aforementioned console.

It is now assumed that when the access history table 32 of control server 11 is brought into the status as shown in FIG. 6, the prediction block 33 starts a prediction operation. The prediction block 33 searches an entry 40 of access history table 33 to select a sever ID field corresponding to a status field at which an identifier “real” is registered. If there are a plurality of subordinate servers placed in real registration status, any one of them is selected. The criterion for the selection can be set arbitrarily. If a subordinate server corresponding to a server ID field which is hit to “real” first is selected, the time for searching the access history table can be reduced. Since, in the status of FIG. 6, only one subordinate server is present which is placed in real registration status, the server 13 is selected.

Next, a command packet is transmitted from the control server 11 to the server 13 so that data 700 may be copied to the subordinate server 15 which has not yet been recorded in the entry 40. The control server 11 adds a server ID 15 of the server 15 at a blank server ID field in the entry 40. The entry 40 exhibits a status as shown in FIG. 7. Following the command packet, the server 13 transmits to the sever 15 a packet carrying the data 700. When receiving the packet, the server 15 registers the data 700 in the cache. Thereafter, when the client 20 transmits a packet for requesting acquisition of the data 700, the cache server 15 returns a response packet carrying the data 700 held in the cache.

(Embodiment 2)

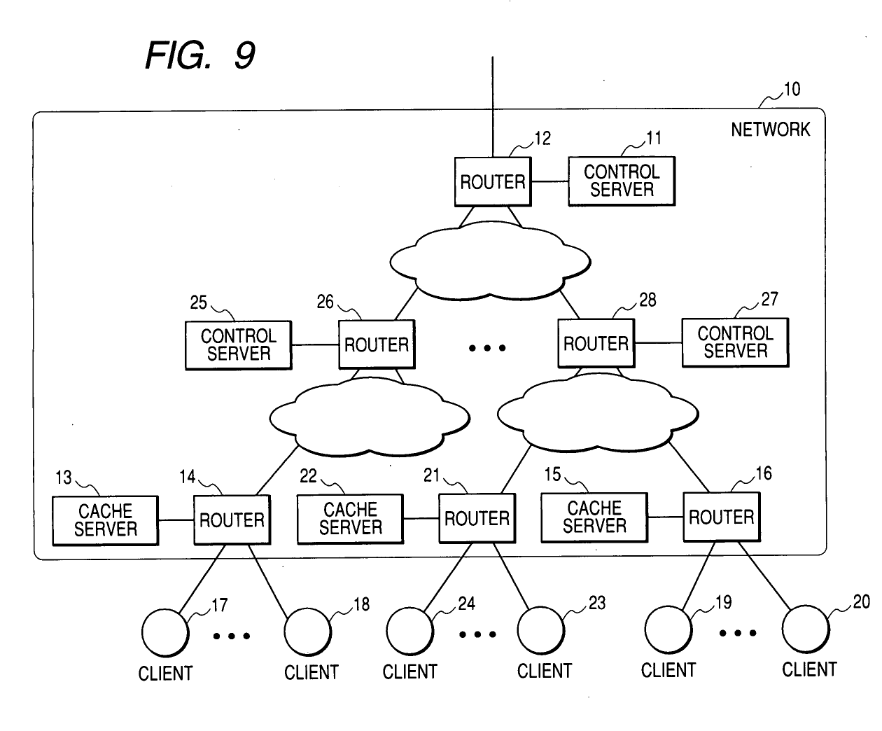

In Embodiment 2, the present invention is applied to a network of a hierarchical construction having a plurality of control servers. The network construction of the present embodiment is exemplified in FIG. 9.

A first router group includes routers 14, 16 and 21 which are provided most closely to individual clients. The first routers accommodate multiple client groups 17 to 18, 19 to 20 and 23 to 24, respectively. Designated by 13, 15 and 22 are cache servers connected to the first routers 14, 16 and 21, respectively. A second router 12 is located at a connection portion to another network. A control server 11 is connected to the second router 12. Control servers 25 and 27 are connected to intermediate routers and called intermediate control servers. The routers 26 and 28 constitute a router group interposed between the first router group and the second router, the thus constituted router group being hereinafter termed an intermediate router group. The first router group and the intermediate router group are connected together through any type of networks. The second router is connected to the intermediate router group through a network different from the above. No intermediate control server is provided in the aforementioned network groups.

In the present embodiment, as viewed from an arbitrary server arranged on the network, a server arranged closely to a client is called a subordinate server and a server arranged closely to a router connected to a core network is called a superordinate server. Though not illustrated in FIG. 9, a line extending onto the second router 12 is connected to a network at a further depth on the network topology (called a core network). A server superordinate to control server 11 which is the closest to the core network is one of servers holding original data requested to be accessed by the individual clients and cache servers or the intermediate servers, which one server is present on a different network and is called an original server. The control server 11 is connected to the original sever through the medium of the core network.

The cache servers 13, 15 and 22 do not directly communicate with the control server 11 but communicate with the intermediate control servers 25 and 27. The intermediate control servers control subordinate cache servers connected by the network. For example, the control server 25 controls the cache server 13 and the control server 27 controls the cache servers 15 and 22. The control server 11 controls the intermediate control servers 25 and 27.

Next, an operational example of the network having the FIG. 9's topology will be described. Herein, an operation will be described which is carried out when in the network of the topology having hierarchical control servers as shown in FIG. 9, the control server 11 determines, as the result of a prediction operation, that data is to be copied from an arbitrary cache server controlled by the intermediate control server 25 to cache servers controlled by the intermediate control server 27. The control server 11 does not transmit a command directly to the cache servers but transmits it through the medium of the intermediate control servers controlled by the control server 11.

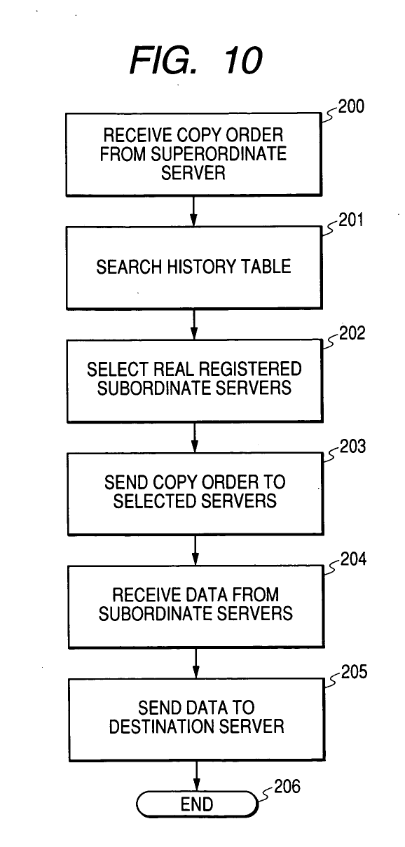

The control server 11 now transmits to the subordinate server 25 a packet carrying a command to order it to transfer or copy data to the subordinate server 27. The control server 25 representing an intermediate control server operates in accordance with a flow of FIG. 10. When receiving a transfer command from the control server 11 representing the superordinate control server in Step 200, the control server 25 searches its access history table in Step 201 and selects an entry of the data. In Step 202, the control server 25 selects one really registered subordinate server from the entry. In this instance, the control server 25 selects, for example, the cache server 13 and then, in Step 203, transmits to the server 13 a packet carrying a data transfer or copy order. The server 13 takes out the data from the cache and returns a reply packet to the control server 25.

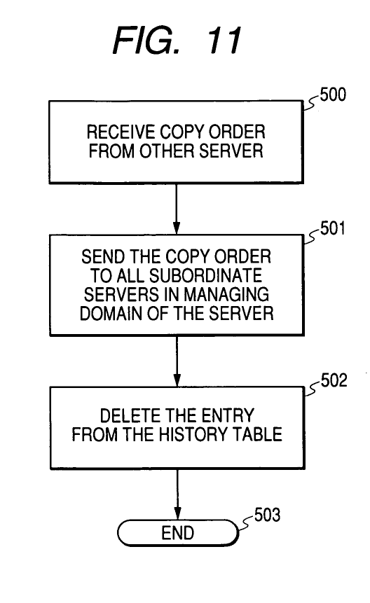

When receiving the reply packet in Step 204, the control server 25 transfers, in Step 205, the data to the control server 27 commanded by the packet. The control server 27 on the receiving side operates in accordance with a flow of FIG. 11. Upon reception of the copy packet from the control server 25 in Step 500, the control server 27 transmits, in Step 501, a packet necessary for copying the data to all subordinate servers controlled by the control server 27. In Step 502, the control server 27 deletes the entry corresponding to the data from the access history table.

In the present embodiment, the data may be transferred by way of the superordinate server. Also, in the present embodiment, one or more subordinate servers may be selected in Step 501, the data may be transferred to only the selected servers and in Step 502, instead of deleting the entry, the selected subordinate servers may be registered in the entry. When the network is made to have the hierarchical structure as in the present embodiment, a server is required to manage only a directly subordinate server and the amount of data to be managed can be suppressed. Accordingly, the present embodiment can be adapted for a network having a larger scale than that of the network of the topology in Embodiment 1.

(Embodiment 3)

In the present embodiment, an example in which a demand for data is predicted using an algorithm different from the control server in Embodiment 1 will be described using FIG. 2.

When the packet handler 30 receives a packet from the second router 12, it transfers the received packet to the request processing block 31. The request processing block 31 starts the prediction block 33 to cause it to execute a prediction of a demand for data.

The prediction block 33 searches the access history table 32 to search an entry in which data of an ID subject to a demand prediction is stored at data ID field. When the entry storing the intended data is hit, the prediction block 33 searches the entry of interest to cause the counter 38 to count the number of server ID fields corresponding to not blanked status fields, that is, status fields recorded with identifiers “temporary” or “real”. The counted number of server ID's is inputted to the comparator 37 from the counter. The comparator 37 acquires a threshold for demand prediction decision from the threshold register 35 and compares the inputted server number with the threshold. When the number of servers counted by the counter is larger than the threshold, the demand for the data is determined as increasing but when smaller than the threshold, it is determined that the demand for accessing that data will not increase even after the present time point. A result of decision is transmitted to the request processing block 31.

The request processing block 31 execute a copy order on the basis of the result transmitted from the prediction block 33. Like Embodiment 1, when the decision result transmitted from the prediction block 33 indicates an increasing demand, the request processing block 31 transmits, to a cache server holding the data requested to be accessed, an order to cause it to copy that data to not only the cache server representing the access request source but also all subordinate cache servers. Alternatively, the data sent from the original server is transmitted to all subordinate cache servers. If the result of prediction in the prediction block 33 does not indicate an increasing demand, the data of interest is transferred to only the cache server subject to data access request.

Like Embodiment 1, by providing the console in the control server, the system user can freely change the value of the threshold register. For example, if the majority of subordinate servers managed by the control server 11 are set as the threshold, data requested to be accessed can be so determined as to undergo an increasing demand when the number of really or temporarily registered subordinate servers exceeds the majority of servers subordinate to the control server 11.

In addition, like Embodiment 1, the prediction block 33 may be provided with the learning function to optimize the threshold set in the threshold register.

(Embodiment 4)

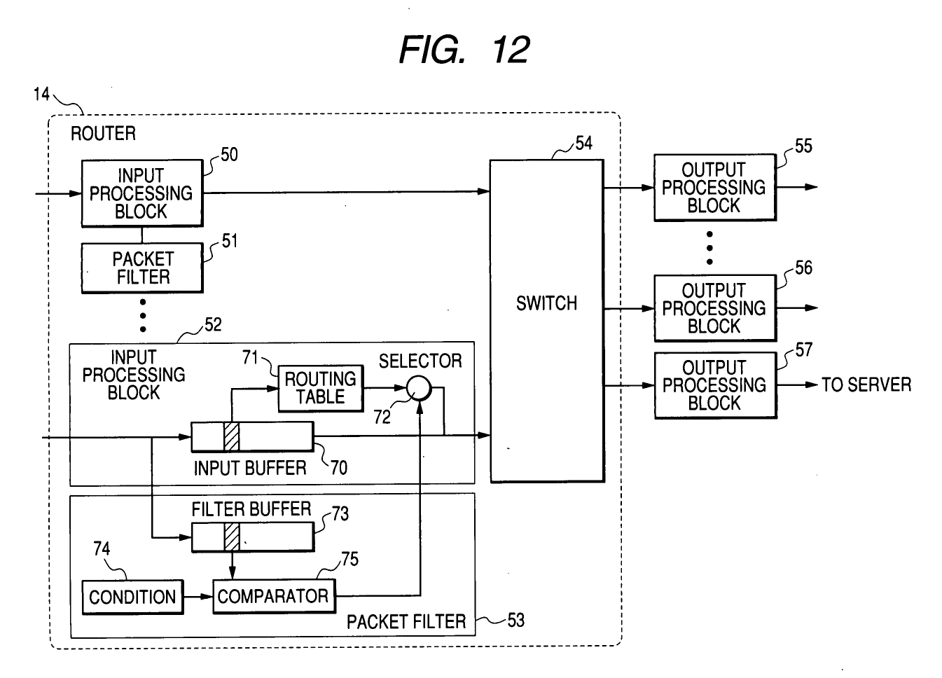

In the present embodiment, the construction of a node unit particularly suitable for the first routers in the network system of the present invention will be described. The node unit according to the present embodiment has a packet filter and has a function to transfer to a cache server a data request packet transmitted to an original server by a client. An example of the construction of the node unit with packet filter according to the present embodiment is illustrated in FIG. 12.

Input processing blocks 50 and 52 of the router 14 are added with packet filters 51 and 53. The input processing block 52 includes an input buffer 70, a routing table 71 and a selector 72. The packet filter 53 includes a filter buffer 73, a condition register 74 and a comparator 75.

A packet reaching the input processing block 52 is fetched by the input buffer 70 and filter buffer 73. A specified field of the packet fetched by the input buffer 70 is used as a key for searching the routing table 71. Part of the packet fetched by the filter buffer 73 is compared with a value of the condition register 74 by means of the comparator 75. A result of comparison is sent to the selector 72. The selector 72 responds to an output of the comparator 75 to select one of numbers of output processing blocks 55, 56 and 57 which is an output of the routing table 71 and a number of the output processing block 57 connected to a server. When the comparator 75 delivers truth, the selector 72 delivers a number corresponding to the output processing block 57 but when the comparator 75 delivers false, the selector 72 delivers the output of routing table 71. As the condition of filtering by the packet filter 53, destination IP address, destination port number, source port number or URL can be used. Further, the sum or product of the above conditions in combination can be adopted. A switch 54 delivers the packet held in the input buffer 70 to any of the output processing blocks 55, 56 and 57 on the basis of the output of the selector 72 of each input processing block 50 or 52.

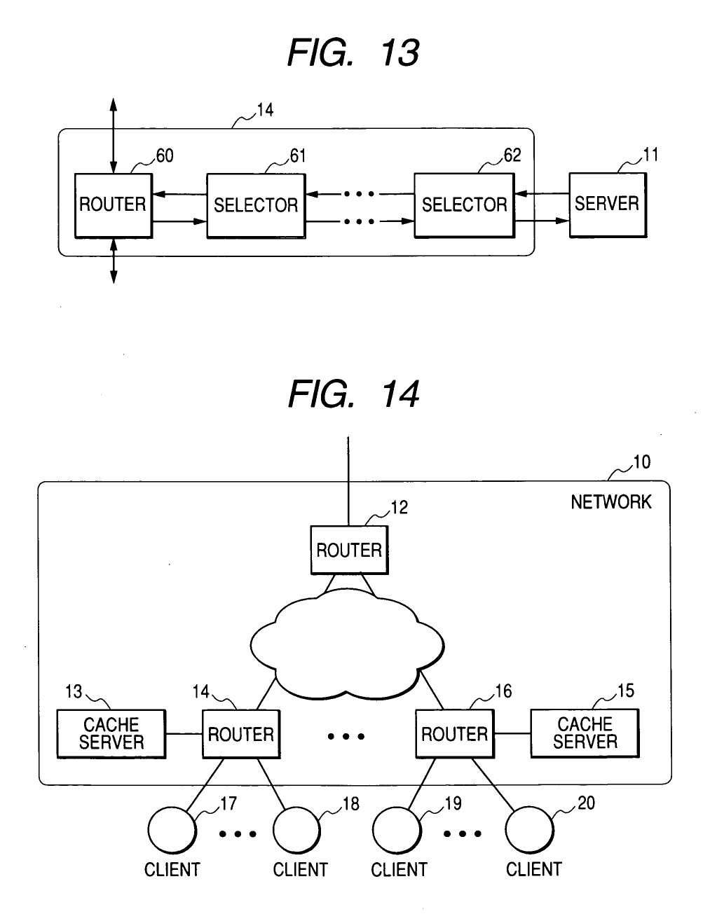

The router 14 has been described as using a single stage of filter but structurally, filters may be connected in tandem as shown in FIG. 13. By carrying out a pipeline process in such a manner that a filer close to the router 14 uses a value at a fixed position in the packet such as a destination IP address to perform a high-speed process and a filter close to the server performs a complicated low-speed process required by comparison of values of variable size at variable positions, such as comparison of URL's, thereby ensuring that compatibility between the processing speed throughout the system and the highly graded processing contents can be maintained.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A network system comprising:
a plurality of cache servers to which a plurality of clients connect; and
a control server for controlling said plurality of cache servers,
wherein said control server predicts data a request for coming access to which is expected to be made to a cache server, and copies the predicted data to a different cache server to which a request for access to said predicted data is not made at present.

2. A network system according to claim 1, wherein said control server has a table for storing a history of access to cache data stored in the cache servers from the client.

3. A network system according to claim 2, wherein said table stores an ID of the data held in said cache servers.

4. A network system according to claim 1, wherein multiple control servers are provided and a superordinate control server is connected to said multiple control servers.

5. A cache control method for use in a network having a plurality of cache servers, comprising:
a step of predicting data a request for access to which is made to a cache server; and
a step of copying the predicted data from one of said plurality of cache servers which caches said predicted data to a different cache servers.

6. A cache control method according to claim 5, wherein:
said network has a control server for controlling said plurality of cache servers, and
when any cache server caching said predicted data is not present, said control server makes, to a server holding original data of said predicted data, a request for transfer of the data.

7. A cache control method according to claim 5, wherein:
said control server includes a history table recording ID's of data held in cache servers, and
said control server predicts data which is expected to be access, on the basis of a status of said history table or a change in status.

8. A cache control method according to claim 5, wherein multiple control servers are provided and a superordinate control server controls said multiple control servers.

9. A control server connected to a plurality of cache servers connected with a plurality of clients, comprising:
a memory for storing a history table recorded with an ID of data which is requested by a client to a cache server and an ID of a cache server representing a source of requesting said data;
a prediction block for predicting data which is expected to be access next, on the basis of said history table; and
a request processing block for transmitting, to a cache server caching the predicted data, an order to cause it to copy said data.

10. A control server according to claim 9, wherein:
said prediction block decides whether the ID of said requested data has already been registered in said history table, and
when the ID of said data has not yet been registered, prepares an entry in said history table newly, records the ID of said cache server representing the source of requesting said data and registers the ID of said data temporarily.

11. A control server according to claim 10, wherein:
said request processing block transmits, to a server holding original data of said data, a request for transfer of said data, and
after receiving a response from said server holding the original data, changes said ID placed in temporary registration status to real registration status.

12. A control server according to claim 11, wherein when normally receiving a response from said server holding said original data, said control server transfers said response to the server placed in the temporary registration status in said entry.

13. A control server according to claim 10, wherein when an entry corresponding to the requested data has already been present in said history table and a cache server placed in a real registration status is not present, the ID of the request source cache server is temporarily registered in said entry.

14. A control server according to claim 10, wherein:
when an entry is present in said history table and a plurality of cache servers placed in real registration status are present, said prediction block selects one of said cache servers placed in real registration status, and
said request processing block orders said selected cache server to copy said requested data to said request source cache server.
